(19) United States
(12) Patent Application Publication
(10) Pub. No.: US 2023/0367236 A1
(43) Pub. Date: Nov. 16, 2023

(54) RESIN PARTICLE AND TONER

(71) Applicants: Natsuko Matsushita, Shizuoka (JP); Yuka Mizoguchi, Shizuoka (JP); Junichi Watanabe, Shizuoka (JP); Kazuoki Fuwa, Shizuoka (JP)

(72) Inventors: Natsuko Matsushita, Shizuoka (JP); Yuka Mizoguchi, Shizuoka (JP); Junichi Watanabe, Shizuoka (JP); Kazuoki Fuwa, Shizuoka (JP)

(73) Assignee: Ricoh Company, Ltd., Tokyo (JP)

(21) Appl. No.: 18/314,218

(22) Filed: May 9, 2023

(30) Foreign Application Priority Data
May 11, 2022 (JP) 2022-078454
Mar. 7, 2023 (JP) 2023-034967

(51) Int. Cl. G03G 9/093

(52) U.S. Cl. CPC G03G 9/09328; G03G 9/09371

(57) ABSTRACT

A resin particle contains a core containing a first binder resin containing an alcohol component and a shell containing a second binder resin containing at least one of polyethylene terephthalate and polybutylene terephthalate, wherein the first binder resin contains a plant-derived alcohol monomer accounting for 5 to 35 percent by mass of the entire of the alcohol component and the at least one of polyethylene terephthalate and polybutylene terephthalate accounts for 10 to 70 percent by mass of the entire of the second binder resin.

### CROSS-REFERENCE TO RELATED APPLICATIONS

This patent application is based on and claims priority pursuant to 35 U.S.C. § 119 to Japanese Patent Application Nos. 2022-078454 and 2023-034967, filed on May 11, 2022 and Mar. 7, 2023, respectively, in the Japan Patent Office, the entire disclosures of which are hereby incorporated by reference herein.

### BACKGROUND

### Technical Field

The present disclosure is related to a resin particle and toner.

### Description of the Related Art

Toners are required to reduce their burden on the environment. Reducing the energy consumed in a manufacturing process and adopting a plant-derived resin for binder resin have been reviewed.

### SUMMARY

According to embodiments of the present disclosure, a resin particle is provided which contains a core containing a first binder resin containing an alcohol component and a shell containing a second binder resin containing at least one of polyethylene terephthalate and polybutylene terephthalate, wherein the first binder resin contains a plant-derived alcohol monomer accounting for 5 to 35 percent by mass of the entire of the alcohol component and the at least one of polyethylene terephthalate and polybutylene terephthalate accounts for 10 to 70 percent by mass of the entire of the second binder resin.

As another aspect of embodiments of the present disclosure, a toner is provided which contains the resin particle mentioned above.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, a resin particle is provided which can produce a toner causing less environmental burden with excellent strength and low temperature fixability.

Embodiments of the present disclosure are described below.

Resin Particle

The resin particle relating to the embodiments of the present disclosure has a core-shell structure including a core and a shell.

Core

The core constitutes the core portion of a resin particle with a core-shell structure. The core contains a binder resin. The binder resin in the core is an example of the first binder resin in the present embodiment.

The binder resin preferably includes an amorphous polyester resin advantageous to achieve excellent low temperature fixability. Of these, a linear polyester resin is preferable. In addition, an unmodified polyester resin is preferable.

The linear polyester resin has a linear main chain or a linear main chain with a relatively short side chain bonded with the linear main chain.

The non-modified polyester resin is prepared by a polyol with a polycarboxylic acid including a polycarboxylic anhydride and polycarboxylic acid ester or their derivatives. This non-modified polyester resin is not modified with an isocyanate compound.

Preferably, the amorphous polyester resin does not have a urethane or urea bonding.

The amorphous polyester resin contains a dicarboxylic acid component, which preferably contains terephthalic acid in an amount of 50 mol percent or greater. This proportion is advantageous in terms of high temperature storage stability.

One of the polyols is a diol.

Specific examples of diol includes, but are not limited to, an adduct of bisphenol A with alkylene (having two or three carbon atoms) oxide (average adduction mol number of from 1 to 10) such as polyoxypropylene(2,2)-2,2-bis(4-hydroxyphenyl)propane, polyoxyethylene(2,2)-2,2-bis(4-hydroxyphenyl)propane, ethylene glycol, propylene glycol, hydrogenated bisphenol A, and an adduct of hydrogenated bisphenol A with an alkylene (having two or three carbon atoms) oxide (average adduction mol number of from 1 to 10). These can be used alone or in combination.

A specific example of the polycarboxylic acid is dicarboxylic acid.

Specific examples of dicarboxylic acid include, but are not limited to, adipic acid, phthalic acid, isophthalic acid, terephthalic acid, fumaric acid, maleic acid, and succinic acid substituted with an alkyl group having 1 to 20 carbon atoms or alkenyl group having 2 to 20 carbon atoms such as dodecenyl succinic acid and octyl succinic acid.

These can be used alone or in combination. Of these, dicarboxylic acid containing a plant-derived succinic acid of saturated aliphatic series is preferable.

If dicarboxylic acid is a plant-derived component, the carbon neutrality of a resin particle can be enhanced reducing the burden on the environment. Saturated aliphatic series enhances recrystallization of crystalline polyester resin, increases its aspect ratio, and ameliorates its low temperature fixability.

The amorphous polyester resin may optionally contain at least one of a tri- or higher carboxylic acid and a tri- or higher alcohol to adjust the acid value and hydroxyl value.

Specific examples of tri- or higher carboxylic acid include, but are not limited to, trimellitic acid, pyromellitic acid, and their anhydrides.

Specific examples of tri- or higher alcohol include, but are not limited to, glycerin, pentaerythritol, and trimethylol propane.

The molecular weight of the amorphous polyester resin is not particularly limited and can be suitably selected to suit to a particular application. The weight average molecular weight Mw of the amorphous polyester resin is preferably from 3,000 to 10,000 and more preferably from 4,000 to 7,000 as measured by gel permeation chromatography (GPC).

Its number average molecular weight Mn is preferably from 1,000 to 4,000 and more preferably from 1,500 to 3,000. The ratio Mw/Mn is preferably from 1.0 to 4.0 and more preferably from 1.0 to 3.5.

A molecular weight of the lower limit mentioned above or higher of the amorphous polyester resin prevents high temperature storage stability of toner made of the resin particle and the toner's durability to stress such as agitation in a developing device from lowering. A molecular weight up to the upper limit mentioned above prevents toner's viscoelasticity from increasing in melting the toner and prevents toner's low temperature fixability from lowering.

The acid value of the amorphous polyester resin is not particularly limited and can be suitably selected to suit to a particular application. The acid value of the amorphous polyester resin is preferably from 1 to 50 mgKOH/g and more preferably from 5 to 30 mgKOH/g.

An acid value of 1 mgKOH/g or greater tends to negatively charge toner when the resin particle is used for the toner. This range also enhances affinity between paper and the toner in fixing it on the paper, achieving good low temperature fixability. An acid value of 50 mgKOH/g or less prevents deterioration of the toner's charging stability, particularly the charging stability to environmental fluctuation.

The hydroxyl value of the amorphous polyester resin is not particularly limited and can be suitably selected to suit to a particular application. The value is preferably 5 mgKOH/g or greater.

The glass transition temperature (Tg) of the amorphous polyester resin is preferably from 40 to 80 degrees C. and more preferably from 50 to 70 degrees C.

At a glass transition temperature of 40 degrees C. or higher, the high temperature storage stability of the toner made of the resin particle is sufficiently enhanced, together with the toner's durability against stress such as agitation in a developing device and the toner's resistance to filming. At a glass transition temperature of 80 degrees C. or lower, the toner made of the resin particle transforms into a good shape under heat and pressure in fixing, thereby enhancing the toner's low temperature fixability.

The molecule structure of amorphous polyester resin can be analyzed by measuring a solution or solid of the resin by a method such as nuclear magnetic resonance (NMR) using, X-ray diffraction (XRD), gas chromatography mass spectrometry (GC/MS), liquid chromatography mass spectrometry (LC/MS), and infrared spectroscopy (IR).

Amorphous polyester resin can be simply detected as a substance without absorbing 965±10 cm⁻¹ and 990±cm⁻¹ based on δCH (out of plane bending vibration) of olefin in infrared absorption spectrum.

The proportion of the amorphous polyester resin is not particularly limited and can be suitably selected to suit to a particular application. It is preferably from 50 to 90 percent by mass and more preferably from 60 to 80 parts by mass to the resin particle.

A proportion of 50 percent by mass or greater reduces deterioration of dispersibility of a pigment and releasing agent in toner made of the resin particle and minimizes fogging and disturbance of an image. A proportion of 90 percent by mass or less prevents a decrease in low temperature fixability. When the proportion is in the more preferable region, the resin particle is excellent regarding the image quality and low temperature fixability.

The resin particle of the present disclosure preferably includes a crystalline resin as an additive to enhance the low temperature fixability. The crystalline resin is not particularly limited as long as it has crystallinity and can be suitably selected to suit to a particular application.

The crystalline resin includes, for example, polyester resin, polyurethane resin, polyurea resin, polyamide resin, polyether resin, vinyl resin, and modified crystalline resin. These can be used alone or in combination.

The crystalline polyester resin is described below. The crystalline polyester resin is prepared by a polyol with a polycarboxylic acid including a polycarboxylic anhydride and polycarboxylic acid ester or their derivatives.

In the present embodiment, the crystalline polyester resin does not include a resin obtained by modifying a polyester resin such as a porepolymer and cross-linking or elongating the prepolymer.

The polyol is not particularly limited and can be suitably selected to suit to a particular application. Examples of the polyols include, but are not limited to, diols and tri- or higher alcohols.

One example of the diol is a saturated aliphatic diol. The saturated aliphatic diol includes straight chain saturated aliphatic diol and branch-chain saturated aliphatic diol. Of these, straight-chain saturated aliphatic diol is preferable and straight-chain saturated aliphatic diol with 2 to 12 carbon atoms is more preferable.

If saturated aliphatic diol is of a straight-chain type, crystallinity of the crystalline polyester resin is prevented from deteriorating, which minimizes a decrease in the melting point thereof. A saturated aliphatic diol with 2 to 12 carbon atoms is readily available.

Specific examples of the saturated aliphatic diol include, but are not limited to, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosandecanediol.

Of these, ethylene glycol, 1,4-butanediol, 1,6-hexanediol, 1,8-octanediol, 1,9-nonanediol, 1,10-decanediol, and 1,12-dodecanediol are preferable to enhance crystallinity of the crystalline polyester resin and achieve excellent sharp melting thereof.

Specific examples of the tri- or higher alcohols include, but are not limited to, glycerin, trimethylol ethane, trimethylol propane, and pentaerythritol. These may be used alone or in a combination of two or more thereof.

The polycarboxylic acid is not particularly limited and can be suitably selected to suit to a particular application. The polycarboxylic acid includes, but are not limited to, a dicarboxylic acid and tri- or higher carboxylic acid.

Specific examples of the dicarboxylic acid include, but are not limited to, saturated aliphatic dicarboxylic acid such as oxalic acid, succinic acid, glutaric acid, adipic acid, suberic acid, azelaic acid, sebacic acid, 1,9-nonane dicarboxylic acid, 1,10-decane dicarboxylic acid, 1,12-dodecane dicarboxylic acid, 1,14-tetradecane dicarboxylic acid, and 1,18-octadecane dicarboxylic acid and aromatic dicarboxylic acids such as phthalic acid, isophthalic acid, terephthalic acid, naphthalene-2,6-dicarboxylic acid, malonic acid, and mesaconic acid. They include anhydrides or lower alkylesters (1 to 3 carbon atoms) thereof.

Of these, plant-derived saturated aliphatic with 12 or less carbon atoms is preferable from a carbon neutral point of view.

Specific examples of the tri- or higher carboxylic acids include, but are not limited to, 1,2,4-benzene tricarboxylic acid, 1,2,5-benzene tricarboxylic acid, 1,2,4-naphtalene tricarboxylic acid, and their anhydrides or lower alkyl esters (1 to 3 carbon atoms). These may be used alone or in a combination of two or more thereof.

The crystalline polyester resin is preferably formed of a straight chain saturated aliphatic dicarboxylic acid with 4 to 12 carbon atoms and a straight chain saturated aliphatic diol with 2 to 12 carbon atoms. This crystalline polyester resin thus demonstrates high crystallinity and excellent sharp melting, thereby achieving excellent low temperature fixability.

One way of controlling the crystallinity and the softening point of the crystalline polyester resin is to design and use a non-linear polyester obtained through polycondensation in which, during polyesterization, polyol including tri- or higher alcohol such as glycerin is added to the alcohol component and polycarboxylic acid including tri- or higher carboxylic acid such as trimellitic anhydride is added.

The molecular structure of the crystalline polyester resin can be confirmed by measuring a solution or solid by methods such as NMR, X ray diffraction, GC/MS, LC/MS, and infrared (IR) absorption measuring.

A simple example is a molecule structure having absorption observed at 965±10 cm⁻¹ or 990±10 cm⁻¹ based on olefin 6CH (out-of-plane deformation vibration) in infrared spectrum.

Based on the knowledge about the molecular weight that a resin having a low molecular weight and a sharp molecular weight distribution demonstrates good low temperature fixability and a resin containing a component having a small molecular weight in a large amount has poor high temperature storage stability, the molecular weight of the crystalline polyester resin preferably has a peak in a range of from 3.5 to 4.0, a peak half width value of 1.5 or less, a weight average molecular weight Mw of from 3,000 to 30,000, a number average molecular weight Mn of from 1,000 to 10,000, and an Mw/Mn of from 1 to 10 in the graph of the molecular weight distribution due to gel permeation chromatography (GPC) of a portion soluble in o-dichlorobenzene with an X axis of log (M) and an Y axis of a molecular weight represented in percent by mass.

The weight average molecular weight Mw is more preferably from 5,000 to 15,000, the number average molecular weight Mn is more preferably from 2,000 to 10,000, and the ratio of Mw/Mn is more preferably from 1 to 5.

The acid value of the crystalline polyester resin for use in producing toner is preferably 5 mgKOH/g or greater to achieve a target low temperature fixability in terms of affinity between paper and the resin. To produce fine particles by phase transfer emulsification, the acid value is more preferably 7 mgKOH/g or greater.

Conversely, to improve the hot offset resistance, the acid value is preferably 45 mgKOH/g or less. The hydroxyl value of a crystalline polymer is preferably from 0 to 50 mgKOH/g and more preferably from 5 to 50 mgKOH/g to achieve a target low temperature fixability and good chargeability.

The crystalline polyester resin in a core may be contained in the binder resin in the core.

The core constituting the resin particle may optionally contain a coloring material, an organic solvent, a prepolymer, a charge control agent, releasing agent, and an additive other than the binder resin and the crystalline polyester resin.

The coloring material is not particularly limited and can be suitably selected to suit to a particular application. Specific examples of the coloring materials include, but are not limited to, known dyes and pigments such as carbon black, Nigrosine dyes, black iron oxide, Naphthol Yellow S, Hansa Yellow (10G, 5G and G), Cadmium Yellow, yellow iron oxide, loess, chrome yellow, Titan Yellow, polyazo yellow, Oil Yellow, Hansa Yellow (GR, A, RN and R), Pigment Yellow L, Benzidine Yellow (G and GR), Permanent Yellow (NCG), Vulcan Fast Yellow (5G and R), Tartrazine Lake, Quinoline Yellow Lake, Anthrazane Yellow BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red FSR, Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, Indanthrene Blue (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone.

These coloring materials can be used alone or in combination.

The proportion of the coloring material is not particularly limited and can be suitably selected to suit to a particular application. The proportion of the coloring material to the resin particle is preferably from 1 to 15 percent by mass and more preferably from 3 to percent by mass.

The coloring material can be used with a resin as a composite master batch.

As the organic solvent, a volatile organic solvent with a boiling point lower than 100 degrees C. is preferable to readily remove the organic solvent later.

Specific examples of the organic solvent include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methylethyl ketone, methylisobuthyl ketone, methanol, ethanol, and isopropyl alcohol.

These organic solvents can be used alone or in combination of two or more thereof.

It is preferable to dissolve or disperse a resin with a polyester backbone in an organic solvent such as ester-based solvents including methyl acetate, ethyl acetate, and butyl acetate or ketone-based solvents including methylethyl ketone and methyl isobutyl ketone because the resin is well dissolved or dispersed in these solvents. Of these, methyl acetate, ethyl acetate, and methyl ethyl ketone are particularly preferable to readily purge a dispersion of the organic solvent later.

One of the prepolymers, reactive precursors, is a polyester with a group reactive with an active hydrogen group.

Specific examples of the group reactive group with an active hydrogen group include, but are not limited to, an isocyanate group, an epoxy group, a carboxylic acid, and an acid chloride group. Of these, an isocyanate group is preferable to introduce a urethane or urea group into an amorphous polyester resin.

The reactive precursor may have a branched structure attributed by at least one of tri- or higher alcohol and tri- or higher carboxylic acid.

One example of the polyester resin containing an isocyanate group is a reaction product of a polyisocyanate and a polyester resin with an active hydrogen group.

One way of obtaining a polyester resin with an active hydrogen group is to polycondense a diol with a dicarboxylic acid or a tri- or higher alcohol with a tri- or higher carboxylic acid. A tri- or higher alcohol and a tri- or higher carboxylic acid provides a branched structure to a polyester resin with an isocyanate group.

Specific examples of the diols include, but are not limited to, aliphatic diols such as ethylene glycol, 1,2-propylene glycol, 1,3-propylene glycol, 1,4-butanediol, 2-methyl-1,3-propanediol, 1,5-pentanediol, 3-methyl-1,5-pentanediol, 1,6-hexanediol, 1,8-octanediol, 1,10-decanediol and 1,12-dodecanediol, diols having oxyalkylene groups such as diethylene glycol, triethylene glycol, dipropylene glycol, polyethylene glycol, polypropylene glycol and polytetramethylene glycol; diols having oxyalkylene groups such as diethylene glycol, triethylene glycol, dipropylene glycol, polyethylene glycol, polypropylene glycol and polytetramethylene ether glycol; alicyclic diols such as 1,4-cyclohexane dimethanol and hydrogenated bisphenol A; adducts of alicyclic diols with an alkylene oxide such as ethylene oxide, propylene oxide, and butylene oxide; bisphenols such as bisphenol A, bisphenol F, and bisphenol S; and adducts of bisphenols with an alkylene oxide such as ethylene oxide, propylene oxide, and butylene oxide.

Of these, aliphatic diols having 3 to 10 carbon atoms such as 1,2-propylene glycol, 1,3-propylene glycol, 1,4-butanediol, 2-methyl-1,3-propanediol, 1,5-pentanediol, and 3-methyl-1,5-pentanediol are preferable to adjust the glass transition temperature of a polyester resin to 20 degrees C. or lower. Using these aliphatic diol at a proportion of 50 percent by mol or greater to the alcohol components in a resin is more preferable. These diols can be used alone or in combination.

The polyester resin is preferably an amorphous resin. A polyester resin having a resin chain with steric hindrance lowers melt viscosity in fixing, thereby readily demonstrating low temperature fixability. Considering this preference, the main chain of an aliphatic diol preferably has the structure represented by the following Chemical Formula 1.

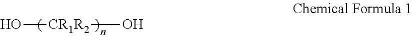

In the Chemical Formula 1, R1 and R2 each independently represent hydrogen atoms or alkyl groups with 1 to 3 carbon atoms and n represents an odd integer of from 3 to 9. R1 and R2 each independently the same or different in the n repeating units.

The main chain of an aliphatic diol refers to a carbon chain linked between the two hydroxy groups of the aliphatic diol with the minimal number. An odd number of carbon atoms in the main chain is preferable because it degrades crystallinity by parity. In addition, aliphatic diol with at least one alkyl group having 1 to 3 carbon atoms in the side chain is preferable, which decreases the mutual action energy between the molecules in the main chain because of steric conformation.

Specific examples of the dicarboxylic acids include, but are not limited to, aliphatic dicarboxylic acids such as succinic acid, adipic acid, sebacic acid, dodecanedioic acid, maleic acid, and fumaric acid and aromatic dicarboxylic acids such as phthalic acid, isophthalic acid, terephthalic acid, naphthalene dicarboxylic acids. In addition, their anhydrides, lower (i.e., 1 to 3 carbon atoms) alkyl esterified compound, and halogenated compounds can be used.

Of these, aliphatic dicarboxylic acid with 4 to 12 carbon atoms are preferable and using 50 percent by mass or greater of the carboxylic acid component in a resin to achieve a glass transition temperature Tg of a polyester resin of 20 degrees C. or lower. These materials can be used alone or in combination.

Specific examples of tri- or higher alcohols include, but are not limited to, tri- or higher aliphatic alcohols such as glycerin, trimethylolethane, trimethylolpropane, pentaerythritol, and sorbitol; tri- or higher polyphenols such as trisphenol PA, phenol novolac, and cresol novolac; and adducts of alkylene oxide such as ethylene oxide, propylene oxide, and butylene oxide with trihydric or higher polyphenols.

One example of tri or higher carboxylic acids is a tri- or higher aromatic carboxylic acid. Tri- or higher aromatic carboxylic acids with 9 to 20 carbon atoms such as trimellitic acid and pyromellitic acid are preferable. In addition, their anhydrides, lower (i.e., 1 to 3 carbon atoms) alkyl esterified compound, and halogenated compounds can be used.

Polyisocyanate is not particularly limited and can be suitably selected to suit to a particular application. Examples include, but are not limited to, diisocyanate and tri- or higher isocyanate.

Specific examples include, but are not limited to, aromatic diisocyanates such as 1,3- or 1,4-phenylene diisocyanate, 2,4- or 2,6-tolylene diisocyanate (TDI), crude TDI, and 2,4′- or 4,4′-diphenyl methane iisocyanate (MDI), 1,5-naphtylene didsocyanate, 4,4′,4″-triphenylmethane triisocyanate, m- and p-isochyanato phenylsupphonyl isocyanate; aliphatic diisocyanates such as ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanatomethyl caproate, bis(2-isocyanatoethyl) fumarate, bis(2-isocyanatoethyl) carbonate, and 2-isocyanatoethyl-2,6-diisocyanatohexanoate; alicyclic diisocyanates such as isophorone diisocyanate (IPDI), dicyclohexylmethane-4,4 diisocyanate (hydrogenated MDI), cyclohexylene diisocyanate, methylcyclohexylene diisocyanate (hydrogenated TDI), bis(2-isocyanatoethyl)-4-cyclohexene-1,2-dicarboxylate and 2,5- and 2, 6-norbornane diisocyanate; aromatic aliphatic diisocyanates such as m- and p-xylylene diisocyanate (XDI) and α,α,α′,α′-tetramethylxylylene diisocyanate (TMXDI); tri- or higher polyisocyanates such as lysine triisocyanate and diisocyanate modified products of tri- or higher alcohols; and modified products of these isocyanates.

These can be used alone or in combination.

Specific examples of the isocyanate modified compounds include, but are not limited to, modified compounds having a urethane group, a carbodiimide group, an allophanate group, a urea group, a biuret group, a uretdione group, a uretimine group, an isocyanulate group, or an oxazoline group.

The charge control agent is not particularly limited and can be suitably selected to suit to a particular application.

Specific examples of the charge control agents include, but are not limited to, nigrosine dyes, triphenylmethane dyes, chrome containing metal complex dyes, chelate pigments of molybdic acid, Rhodamine dyes, alkoxyamines, quaternary ammonium salts (including fluorine-modified quaternary ammonium salts), alkylamides, phosphor and compounds containing phosphor, tungsten and compounds containing tungsten, fluorosurfactants, metal salts of salicylic acid, and metal salts of salicylic acid derivatives.

Specific examples of the charge control agents include, but are not limited to, BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, and a quaternary ammonium group.

The charge control agent is used in an amount within a range in which the charge control agent demonstrates its capability without an adverse impact on the fixability. Its proportion to a resin particle is preferably from 0.5 to 5 percent by mass or less and more preferably from 0.8 to 3 percent by mass.

The releasing agent is not particularly limited and can be suitably selected to suit to a particular application. For example, a releasing agent with a low melting point of from 50 to 120 degrees C. is preferable. A releasing agent with a low melting point works efficiently at the interface between a fixing roller and the resin particle when the releasing agent is dispersed with the resin particle for use in a toner. For this reason, the hot offset resistance is good even in an oil-free configuration, in which a releasing agent like oil is not applied to a fixing roller.

The releasing agent includes waxes. Specific examples of such waxes include, but are not limited to, natural waxes including: plant waxes such as carnauba wax, cotton wax, vegetable wax, and rice wax; animal waxes such as bee wax and lanolin; mineral waxes such as ozokerite; and petroleum waxes such as paraffin, microcrystalline, and petrolatum.

In addition to these natural waxes, synthesis hydrocarbon waxes such as Fischer-Tropsch wax and polyethylene wax and synthesis wax such as ester, ketone, and ether are also usable.

Furthermore, aliphatic acid amide such as 12-hydroxystearic acid amide, stearic acid amide, phthalic acid anhydride imide, and chlorinated hydrocarbons; crystalline polymer resins having a low molecular weight such as homo polymers, for example, poly-n-stearylic methacrylate and poly-n-lauryl methacrylate, and copolymers (for example, copolymers of n-stearyl acrylate-ethylmethacrylate); and crystalline polymer having a long alkyl group in the branched chain are also usable. These can be used alone or in combination.

Of these waxes, plant-derived wax is preferable from a carbon-neutral point of view.

The melting point of wax is not particularly limited and can be suitably selected to suit to a particular application. The melting point is preferably from 50 to 120 degrees C. and more preferably from 60 to 90 degrees C. A melting point of wax of 50 degrees C. or higher prevents an adverse impact of wax on the high temperature storage stability and a melting point of 120 degrees C. or lower prevents cold offset at low temperatures during fixing.

The melt-viscosity of wax is preferably from 5 cps to 1,000 cps and more preferably from 10 cps to 100 cps at a temperature 20 degrees C. higher than the melting point of the wax (releasing agent).

A melt-viscosity of 5 cps or more prevents the degradation of the releasability. A melt-viscosity of 1,000 cps or less will suffice to demonstrate the hot offset resistance and low temperature fixability of a releasing agent.

The proportion of wax to the resin particle mentioned above is not particularly limited and can be suitably selected to suit to a particular application. It is preferably from 0 to 40 percent by mass and more preferably from 3 to 30 percent by mass. A proportion of 40 percent by mass or less prevents fluidity of toner when the resin particle is used for the toner.

The external additive is not particularly limited and can be suitably selected to suit to a particular application. The external additive includes, but is not limited to, inorganic fine particle and polymer-based fine particle.

The inorganic fine particle preferably has a primary particle diameter of from 5 nm to 2 μm, and more preferably from 5 nm to 500 nm.

The specific surface area of the inorganic fine particle is preferably from 20 to 500 m²/g as measured by the BET method.

The proportion of the inorganic fine particle to the resin particle is preferably from 0.01 to 5 percent by mass.

Specific examples of such inorganic fine particles include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride.

The polymer-based fine particles include, but are not limited to, polystyrene, methacrylates, and acrylates obtained by soap-free emulsion polymerization, suspension polymerization, or dispersion polymerization, and polycondensed particles such as silicone, benzoguanamine, and nylon, and polymer particles of thermocuring resin.

Also, fluidizers can be optionally added to the toner. The external additive such as a fluidizer can be subjected to surface treatment to enhance hydrophobicity and prevent deterioration of the fluidity and chargeability in a high humidity environment.

Preferred specific examples of surface treatment agents include, but are not limited to, silane coupling agents, silyl agents, silane coupling agents having a fluorine alkyl group, organic titanate coupling agents, aluminum-based coupling agents, silicone oil, and modified-silicone oil.

Cleaning improvers remove a development agent remaining on an image bearer such as a photoconductor and a primary transfer body.

Specific examples include, but are not limited to, zinc stearate, calcium stearate and metal salts of fatty acid acids such as stearic acid and polymer fine particles such as polymethyl methacrylate fine particles and polystyrene fine particles, which are prepared by a method such as soap-free emulsion polymerization.

Such polymer fine particles preferably have a relatively sharp particle size distribution and a volume average particle size of from 0.01 to 1 μm.

In the present embodiment, the binder resin, the first binder resin, of a core contains a plant-derived alcohol monomer.

Specifically, the plant-derived alcohol monomer is contained in the alcohol composing the amorphous polyester resin contained in the binder resin in the core.

In the present specification, “plant-derived” means obtained from plant-derived materials referred to as biomass. Monomer is the minimum unit constituting a polymer.

The plant-derived alcohol monomer contained in the binder resin is not particularly limited. Using plant-derived ethylene or propylene glycol is preferable.

The binder resin may optionally contain a plant-derived component other than the plant-derived alcohol monomer. The plant-derived component other than the plant-derived alcohol monomer is a plant-derived acid component, preferable examples of which are terephthalic acid and succinic acid.

The proportion of the plant-derived alcohol monomer contained in the binder resin in a core to the alcohol component in the binder resin in the core is from 5 to 35 percent by mass, preferably from 10 to 30 percent by mass, and more preferably from 15 to 25 percent by mass.

A proportion of the plant-derived alcohol monomer contained in the binder resin in a core to the alcohol component in the binder resin in the core of from 5 to 35 percent by mass can provide resin particles from which a toner causing low environmental burden with excellent strength and low temperature fixability is obtained.

A proportion of the plant-derived alcohol monomer contained in the binder resin in a core to the alcohol component in the binder resin in the core of from 10 to 30 percent by mass can provide resin particles from which a toner causing lower environmental burden with excellent strength and low temperature fixability is obtained.

The core may optionally contain another binder resin such as polyethylene terephthalate and/or pobutylene terephthalate. This binder resin optionally contained in the core is an example of the third binder resin in the present embodiment of the present disclosure.

Polyethylene terephthalate (PET) and polybutylene terephthalate (PBT) are both crystalline thermoplastic polyesters.

In the present specification, “and/or” in polyethylene terephthalate and/or polybutylene terephthalate means that the core may contain both PET and PBT or either PET or PBT.

In the present embodiment, PET and/or PBT in the core is preferably recycled resins. In the present specification, the recycled resin means a resin derived from recycling.

PET and/or PBT as recycled resins in a core are obtained by processing recycled products into a flake-like form. Their weight average molecular weight Mw is from about 30,000 to about 90,000. PET and/or PBT as recycled resins are not limited by the molecular weight distribution, composition, method of manufacturing, forms in use of PET and/or PBT.

PET and/or PBT as recycled resins are not limited to recycled products. Fiber waste or pellet out of the specification can be used as PET and/or PBT as recycled resins. The environment-friendly ratio and quality of toners obtained by using the resin particle can be adjusted by adjusting the introducing ratio of recycled PET in synthesizing polyester resins.

The proportion of PET and/or PBT in a core is preferably 10 percent by mass or less, more preferably 7 percent by mass or less, and furthermore preferably 5 percent by mass or less.

Shell

The shell mentioned above refers to the exterior part covering at least a part of the core in a resin particle with a core-shell structure. The shell contains a binder resin. This binder resin contained in the shell is an example of the second binder resin in the present embodiment of the present disclosure.

In the present embodiment, the second binder resin in the shell contains PET and/or PBT.

In the present embodiment, PET and/or PBT in the shell is preferably recycled resins.

PET and/or PBT as recycled resins in the shell are obtained by processing recycled products into a flake-like form. Their weight average molecular weight Mw is from about 30,000 to about 90,000. PET and/or PBT as recycled resins are not limited by the molecular weight distribution, composition, method of manufacturing, forms in use of PET and/or PBT.

PET and/or PBT as recycled resins are not limited to recycled products. Fiber waste or pellet out of the specification can be used as PET and/or PBT as recycled resins. In addition, resin particles using PET and/or PBT as recycled resins for the binder resins of a shell demonstrates low environmental burden and can adjust the quality of toner when the introducing ratio of recycled PET is adjusted in synthesizing polyester resins.

The proportion of the PET and/or PBT contained in the binder resin in the shell to the binder resin in the shell is from 10 to 70 percent by mass, preferably from 20 to 60 percent by mass, and more preferably from 30 to 50 percent by mass.

The above-mentioned binder resin in the core can be used as the binder resin in the shell. The components in the binder resin in the shell may be the same as or different from those of the binder resin in the core.

The thickness of the shell is not particularly limited. The thickness of the shell, defined as the ratio of the average equivalent circle diameter of a resin particle to the average equivalent circle diameter of the core, is preferably from 1.005 to 1.5, more preferably from 1.01 to 1.3, and furthermore preferably from 1.03 to 1.1.

In the present specification, the average equivalent circle diameter can be calculated by binarization of a cross section image of a resin particle observed with a transmission electron microscope (TEM) using an imaging software. The shell's thickness is indicated by the value obtained by dividing the average equivalent circle diameter of a resin particle by the average equivalent circle diameter of the core of the resin particle.

For a typical resin particle, an adduct of bisphenol A-propylene oxide (BPA-PO) or bisphenol A-ethylene oxide (BPA-EO) is used as the alcohol component of the polyester resin in the resin particle to enhance toughness of the polyester resin, thereby enhancing storage stability and durability.

On the other hand, in the present embodiment, as described above, the core's binder resin contains a plant-derived alcohol monomer in a proportion of 5 to 35 percent by mass to the entire of the alcohol component in the core's binder resin. The resin particle obtained can lower the burden on the environment.

However, the resin particle containing a plant-derived alcohol monomer uses less or none of BPA as the biomassing of the alcohol component progresses, which decreases the toughness of the polyester resin in the resin particle. Resultantly, the storage stability and durability of the resin particle deteriorate. Therefore, toner using such resin particles containing a plant-derived alcohol monomer loses its strength, degrading the filming resistance.

In the present embodiment, as described above, the shell's binder resin contains polyethylene terephthalate and/or polybutylene terephthalate in a proportion of from 10 to 70 percent by mass to the entire of the shell's binder resin, which enhances the strength of toner. Therefore, the present embodiment can provide a resin particle that can produce a toner with less environmental burden, excellent strength, and low temperature fixability.

In the present embodiment, as described above, PET and/or PBT in the shell's binder resin are recycled resins. Using PET and/or PBT as recycled resins for the shell's binder resin leads to producing resin particles with less environmental burden while maintaining the toner's strength and low temperature fixability high.

In the present embodiment, as described above, the core may contain PET and/or PBT in a proportion of 10 percent by mass or less to the entire core. Within this proportion of PET and/or PBT, resin particles with less environmental burden can be obtained without degrading the toner's low temperature fixability.

In the present embodiment, as described above, PET and/or PBT in the core's binder resin are recycled resins. Using PET and/or PBT as recycled resins for the shell's binder resin leads to producing resin particles with less environmental burden while maintaining the toner's strength and low temperature fixability high.

In the present embodiment, as described above, the shell's thickness, defined as the ratio of the average equivalent circle diameter of a resin particle to the average equivalent circle diameter of the core, is preferably from 1.005 to 1.5. Within this range of the shell's thickness of resin particles, resin particles with less environmental burden can be obtained without degrading the toner's strength.

Toner

The toner relating to the present embodiment contains the resin particle mentioned above. The toner of the present embodiment is a core-shell resin particle with a core containing the binder resin mentioned above and a shell containing the binder resin mentioned above.

Specifically, the resin particle in the toner of the present embodiment includes a core containing a binder resin containing a plant-derived alcohol monomer in the binder resin in a proportion of from 5 to 35 percent by mass to the entire alcohol component in the core's binder resin and a shell containing a binder resin containing PET and/or PBT in a proportion of from 10 to 70 percent by mass to the entire shell's binder resin.

The toner of the present embodiment thus has the same effect as that of the resin particle mentioned above.

Specifically, toner with excellent strength and low temperature fixability while lowering the environmental burden is obtained because of the core of the resin particle in the toner containing a plant-derived alcohol monomer and the shell of the resin particle in the toner containing PET and/or PBT.

As described above, PET and/or PBT in the shell's binder resin are recycled resins regarding the resin particle contained in the toner of the present embodiment. In the present embodiment, using PET and/or PBT as recycled resins for the shell's binder resin produces toner with less environmental burden while maintaining the toner's strength and low temperature fixability high.

As described above, the core of the resin particle in the toner of the present embodiment may contain PET and/or PBT in a proportion of 10 percent by mass or less to the entire core.

In the present embodiment, within this proportion of PET and/or PBT, toner with less environmental burden can be obtained without degrading the toner's low temperature fixability.

In the present embodiment, as described above, PET and/or PBT in the core's binder resin are recycled resins regarding the resin particle contained in the toner or the present embodiment. In the present embodiment, using PET and/or PBT as recycled resins for the shell's binder resin produces toner with less environmental burden while maintaining the toner's strength and low temperature fixability high.

As described above, the shell's thickness, defined as the ratio of the average equivalent circle diameter to the average equivalent circle diameter of the core, is preferably from 1.005 to 1.5 for a resin particle in the toner of the present embodiment. Within this range of the shell's thickness of resin particles, toner with less environmental burden can be obtained while the toner's strength is maintained high in the present embodiment.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### Examples

Embodiments of the present disclosure are described below in detail with reference to Examples but are not limited thereto. Parts and percent are based on mass in the following unless otherwise specified. The following tests and evaluations are based on the methods below.

Particle Diameter of Resin Particle (Toner)

The diameter of resin particle, toner, is measured with Coulter Multisizer III (manufactured by Beckman Coulter, Inc.). The diameter of the resin particle was measured in the following manner.

A total of 2 mL of a surfactant, dodecyl benzene sulphonic acid sodium, manufactured by Tokyo Chemical Industry Co. Ltd., was added as a dispersant to 100 mL of an electrolyte. The electrolyte used was NaCl aqueous solution at approximately 1 percent prepared by using primary sodium chloride. The electrolyte was ISOTON-II (manufactured by Beckman Coulter, Inc.). A total of 10 mg of a solid measuring sample was added to the liquid mixture containing the electrolyte and surfactant to obtain an electrolyte in which the sample was suspended.

The electrolyte in which the sample was suspended was subjected to dispersing with an ultrasonic wave dispersing device for about one to about three minutes. The toner's volume and number are measured with Coulter Multisizer III with an aperture of 100 μm to calculate the volume distribution and the number distribution. The volume average particle diameter Dv of the toner was calculated from the distributions obtained.

Average Particle Diameter and Average Circularity

In this embodiment, the average particle diameter and average circularity are measured by using a flow-type particle image analyzer, FPIA-3000, manufactured by Sysmex Corporation.

The specific procedure for obtaining the average circularity is as follows: (1) A surfactant as a dispersion agent, preferably 0.1 to 5 ml of an alkylbenzenesulfonic acid salt, is added to 100 to 150 ml of water from which solid impurities have been preliminarily removed; (2) about 0.1 to about 0.5 g of a sample to be measured is added to the mixture prepared in (1); (3) the liquid suspension in which the sample is dispersed with an ultrasonic dispersion device for about 1 to about 3 minutes to achieve a concentration of the particles of from 3,000 to 10,000 particles per microlitter; and (4) the average particle diameter, the average circularity, and the standard deviation (SD) of the circularity are measured with the device mentioned above.

The particle diameter is defined as the equivalent circle diameter. The average particle diameter is obtained from the equivalent circle diameter based on number. The analysis conditions of the flow bed particle image analyzer are as follows.

Limitation to particle diameter: 0.5 μm≤equivalent circle diameter based on number ≤200.0 μm

Limitation to particle shape: 0.93≤circularity≤1.00

The definition of the average circularity in the present embodiment is as follows. Average circularity=(perimeter of circle having same area as that of projected image of particle)/(perimeter of projected image of particle)

Measuring of Molecular Weight

One way of measuring the molecular weight of each component of a toner is as follows.

Gel permeation chromatography (GPC) measuring device: GPC-8220 GPC, manufactured by TOSOH CORPORATION

Column: TSK gel Super HZM-H, 15 cm triplet, manufactured by TOSOH CORPORATION

Temperature: 40 degrees C.

Solvent: THF

Rate of flow: 0.35 mL/minute

Sample: 100 μl of 0.15 percent by mass

Pretreatment of sample: toner is dissolved in tetrahydrofuran (THF) containing a stabilizer, manufactured by Wako Pure Chemical Industries, Ltd., at 0.15 percent by mass, followed by filtering with a 0.2 μm filter. The filtrate is used as a sample. A total of 100 μL of the THF sample solution is infused into a measuring device.

For the molecular weight measuring, the molecular weight distribution of a sample is calculated according to the relationship between the number of counts and the logarithm values of the calibration curve created from several types of the monodispersed polystyrene reference samples.

As the reference polystyrene sample for the calibration curve, Showdex STANDARD Std. No. S-7300, S-210, S-390, S-875, S-1980, S-10.9, S-629, S-3.0, and S-0.580, all manufactured by Showa Denko K.K., are used. A refractive index (RI) detector is used as a detector.

Shell's Thickness

The shell's thickness is measured based on the cross section image of an ultra thin piece of toner using a transmission electron microscope (TEM).

The shell's thickness is the value obtained by the calculation according to the following relationship. It is preferable to obtain the shell's thickness using an image processing software; however, the devices are not limited to the TEM, image analyzer, or software mentioned above as long as the same analysis results are obtained.

Shell's thickness=average equivalent circle diameter of core-shell resin particle/average equivalent circle diameter of core

The average equivalent circle diameter can be calculated by binarization with an imaging software.

Observation and Measuring with TEM

The toner manufactured is cured by embedding in an epoxy resin. An ultra thin piece with a thickness of about 100 nm of the toner is prepared with an ultramicrotome (ULTRACUT UCT, using a diamond knife, available from Leica Corporation).

The sample is exposed to gas of ruthenium tetroxide, osmium tetroxide, or another dyeing agent to distinguish the core from the shell layer. The time spent in the exposure is appropriately adjusted depending on the contrast during observation. Thereafter, the sample is observed with TEM, JEM-2100, manufactured by JEOL Ltd. at an accelerating voltage of 100 kV

Imparting a compositional contrast by another method such as selective etching is also possible. Observing and evaluating the core and shell layer using a TEM after such a pre-treatment is also preferable.

The average equivalent circle diameter of the core-shell resin particle and the average equivalent circle diameter of the core of the cross section image are calculated by binarization using a procurable imaging software such as Image-Pro Plus. The average equivalent circle diameter is obtained from 20 toner cross sections.

Analysis of Resin Composition of Surface Layer

Whether the surface layer contains a PET-derived resin component can be confirmed by the composition analysis of the surface layer using nanoIR. The composition is analyzed by obtaining the IR spectrum of a fine particle surface layer according to the analysis for realizing the nanoscale resolution by the combination of nano IR and AFM. Whether the PET derived composition is present in the surface layer can be determined by this analysis.

Analysis of Toner Constituting Component

The plant-derived alcohol monomer, PET, and PBT can be analyzed by using any method. One way of analyzing a composition is to separate each component from a toner using a gel permeation chromatography (GPC) and qualify each of the separated components by the method of analyzing described later.

The main components can be deducible from soft decomposition in methylaytion of the ester linking part of a resin structure according to the gas chromatography mass analysis at 300 degrees C. using a reactive agent (10 percent solution of tetramethyl ammonium hydroxide (TMAH) and methanol).

Synthesis of an amorphous polyester resin is described below. Biomass-derived alcohol and petroleum-derived alcohol were added at the ratio shown in Table 1 in synthesizing an amorphous polyester resin.

Synthesis of Amorphous Polyester Resin B-1

An adduct of bisphenol A with 2 mols of ethylene oxide, an adduct of bisphenol A with 2 mols of propylene oxide, terephthalic acid, and adipic acid were placed in a four-necked flask equipped with a nitrogen introducing tube, a dehydration tube, a stirrer, and a thermocouple at a molar ratio of the adduct of bisphenol A with 2 mols of ethylene oxide to the adduct of bisphenol A with 2 mols of propylene oxide of 60:40, a molar ratio of terephthalic acid to adipic acid of 97:3, and a molar ratio of hydroxyl group to carboxyl group, OH to COOH, of 1.3:1 followed by allowing to react together with titanium tetraisopropoxide (500 ppm to the resin portion) at 230 degrees C. under normal pressure for eight hours and further react under a reduced pressure of from 10 to 15 mmHg for four hours. Then trimellitic anhydride was placed in the reaction container to achieve a proportion of 1 mol percent to the entire resin component followed by allowing to react at 180 degrees C. under normal pressure for three hours, thereby obtaining amorphous polyester (Pes) resin B-1.

Synthesis of Amorphous Polyester Resin B-2

Plant-derived propylene glycol, an adduct of bisphenol A with 2 mols of propylene oxide, terephthalic acid, and plant-derived succinic acid were placed in a four-necked flask equipped with a nitrogen introducing tube, a dehydration tube, a stirrer, and a thermocouple at a molar ratio of the plant-derived propylene glycol to the adduct of bisphenol A with 2 mols of propylene oxide at 4:96, a molar ratio of terephthalic acid to succinic acid of 86:14, and a molar ratio of hydroxyl group to carboxyl group, OH to COOH, of 1.3:1 followed by allowing to react together with titanium tetraisopropoxide (500 ppm to the resin portion) at 230 degrees C. under normal pressure for eight hours and subsequently react under a reduced pressure of from 10 to 15 mmHg for four hours. Then trimellitic anhydride was placed in the reaction container to achieve a proportion of 1 mol percent to the entire resin component followed by allowing to react at 180 degrees C. under normal pressure for three hours, thereby obtaining amorphous polyester (Pes) resin B-2.

Synthesis of Amorphous Polyester Resin B-3

Plant-derived propylene glycol, an adduct of bisphenol A with 2 mols of propylene oxide, terephthalic acid, and plant-derived succinic acid were placed in a four-necked flask equipped with a nitrogen introducing tube, a dehydration tube, a stirrer, and a thermocouple at a molar ratio of the plant-derived propylene glycol to the adduct of bisphenol A with 2 mols of propylene oxide at 40:60, a molar ratio of terephthalic acid to succinic acid of 86:14, and a molar ratio of hydroxyl group to carboxyl group, OH to COOH, of 1.3:1 followed by allowing to react together with titanium tetraisopropoxide (500 ppm to the resin portion) at 230 degrees C. under normal pressure for eight hours and subsequently react under a reduced pressure of from 10 to 15 mmHg for four hours. Then trimellitic anhydride was placed in the reaction container to achieve a proportion of 1 mol percent to the entire resin component followed by allowing to react at 180 degrees C. under normal pressure for three hours, thereby obtaining amorphous polyester (Pes) resin B-3.

Synthesis of Amorphous Polyester Resin B-4

Plant-derived propylene glycol, an adduct of bisphenol A with 2 mols of propylene oxide, terephthalic acid, and plant-derived succinic acid were placed in a four-necked flask equipped with a nitrogen introducing tube, a dehydration tube, a stirrer, and a thermocouple at a molar ratio of the plant-derived propylene glycol to the adduct of bisphenol A with 2 mols of propylene oxide at 5:95, a molar ratio of terephthalic acid to succinic acid of 86:14, and a molar ratio of hydroxyl group to carboxyl group, OH to COOH, of 1.3:1 followed by allowing to react together with titanium tetraisopropoxide (500 ppm to the resin portion) at 230 degrees C. under normal pressure for eight hours and subsequently react under a reduced pressure of from 10 to 15 mmHg for four hours. Then trimellitic anhydride was placed in the reaction container to achieve a proportion of 1 mol percent to the entire resin component followed by allowing to react at 180 degrees C. under normal pressure for three hours, thereby obtaining amorphous polyester (Pes) resin B-4.

Synthesis of Amorphous Polyester Resin B-5

Plant-derived propylene glycol, an adduct of bisphenol A with 2 mols of propylene oxide, terephthalic acid, and plant-derived succinic acid were placed in a four-necked flask equipped with a nitrogen introducing tube, a dehydration tube, a stirrer, and a thermocouple at a molar ratio of the plant-derived propylene glycol to the adduct of bisphenol A with 2 mols of propylene oxide at 20:80, a molar ratio of terephthalic acid to succinic acid of 86:14, and a molar ratio of hydroxyl group to carboxyl group, OH to COOH, of 1.3:1 followed by allowing to react together with titanium tetraisopropoxide (500 ppm to the resin portion) at 230 degrees C. under normal pressure for eight hours and subsequently react under a reduced pressure of from 10 to 15 mmHg for four hours. Then trimellitic anhydride was placed in the reaction container to achieve a proportion of 1 mol percent to the entire resin component followed by allowing to react at 180 degrees C. under normal pressure for three hours, thereby obtaining amorphous polyester (Pes) resin B-5.

Synthesis of Amorphous Polyester Resin B-6

Plant-derived propylene glycol, an adduct of bisphenol A with 2 mols of propylene oxide, terephthalic acid, and plant-derived succinic acid were placed in a four-necked flask equipped with a nitrogen introducing tube, a dehydration tube, a stirrer, and a thermocouple at a molar ratio of the plant-derived propylene glycol to the adduct of bisphenol A with 2 mols of propylene oxide at 30:70, a molar ratio of terephthalic acid to succinic acid of 86:14, and a molar ratio of hydroxyl group to carboxyl group, OH to COOH, of 1.3:1 followed by allowing to react together with titanium tetraisopropoxide (500 ppm to the resin portion) at 230 degrees C. under normal pressure for eight hours and subsequently react under a reduced pressure of from 10 to 15 mmHg for four hours. Then trimellitic anhydride was placed in the reaction container to achieve a proportion of 1 mol percent to the entire resin component followed by allowing to react at 180 degrees C. under normal pressure for three hours, thereby obtaining amorphous polyester (Pes) resin B-6.

TABLE 1

Binder Resin

| | Plant-derived | Petroleum-derived |
|---|---|---|
| | alcohol ratio (percent) | alcohol ratio (percent) |
| Example 1 | 5 | 95 |
| Example 2 | 20 | 80 |
| Example 3 | 30 | 70 |
| Example 4 | 30 | 70 |
| Example 5 | 5 | 95 |
| Example 6 | 20 | 80 |
| Example 7 | 30 | 70 |
| Comparative | 0 | 100 |
| Example 1 | | |
| Comparative | 4 | 96 |
| Example 2 | | |
| Comparative | 40 | 60 |
| Example 3 | | |

Preparation of Liquid Dispersion W-1 of Wax

A total of 180 parts of ester wax (WE-11, synthetic wax of plant-derived monomer, melting point of 67 degrees C., manufactured by NOF CORPORATION) and 17 parts of anionic surfactant (NEOGEN SC, sodium dodecylbenzenesulfonate, manufactured by DKS Co., Ltd.) were added to 720 parts of deionized water. The resulting mixture was subjected to dispersion with a homogenizer to obtain liquid dispersion W-1 of wax while being heated to 90 degrees C. The volume average particle diameter of the wax particles obtained was 250 nm and the solid portion concentration of the resin particle was 25 percent.

Preparation of Master Batch (MB)

A total of 1,200 parts of water, 500 parts of carbon black (Printex 35, manufactured by Degussa AG, DBP oil absorption amount of 42 ml/100 mg, PH of 9.5), and 500 parts of amorphous polyester resin B-1 were admixed by a Henschel Mixer (manufactured by NIPPON COKE & ENGINEERING. CO., LTD.). The mixture was kneaded at 150 degrees C. for 30 minutes using two rolls and rolled and cooled down followed by pulverization with a pulverizer to obtain a master batch MB-1.

Introduction of Polyethylene Terephthalate (PET)

Flake-like recycled PET P-1 was mixed with the amorphous polyester resins B-4 to B-6 synthesized as described above at a solid content ratio shown in Table 2.

TABLE 2

| | Composition | | | | Solid content (percent by mass) | | | |
|---|---|---|---|---|---|---|---|---|
| Resin | | Amorphous | | | | Amorphous | | |
| particle | Wax | Pes resin | PET | MB | Wax | Pes resin | PET | MB |
| Resin particle | W-1 | B-1 | — | MB-1 | 50 | 750 | 0 | 100 |
| 1 | | | | | | | | |
| Resin particle | W-1 | B-2 | — | MB-1 | 50 | 750 | 0 | 100 |
| 2 | | | | | | | | |
| Resin particle | W-1 | B-3 | — | MB-1 | 50 | 750 | 0 | 100 |
| 3 | | | | | | | | |
| Resin particle | W-1 | B-4 | — | MB-1 | 50 | 750 | 0 | 100 |
| 4 | | | | | | | | |
| Resin particle | W-1 | B-5 | — | MB-1 | 50 | 750 | 0 | 100 |
| 5 | | | | | | | | |
| Resin particle | W-1 | B-6 | — | MB-1 | 50 | 750 | 0 | 100 |
| 6 | | | | | | | | |
| Resin particle | W-1 | B-6 | — | MB-1 | 50 | 750 | 0 | 100 |
| 7 | | | | | | | | |
| Resin particle | W-1 | B-4 | P-1 | MB-1 | 50 | 720 | 30 | 100 |
| 8 | | | | | | | | |
| Resin particle | W-1 | B-5 | P-1 | MB-1 | 50 | 720 | 30 | 100 |
| 9 | | | | | | | | |
| Resin particle | W-1 | B-6 | P-1 | MB-1 | 50 | 720 | 30 | 100 |
| 10 | | | | | | | | |

Preparation of Oil Phase

A total of 200 parts (50 parts in solid) of the liquid dispersion W-1 of wax, 750 parts (0 parts of PET) of the amorphous polyester resin B-1, and 100 parts of master batch MB-1 (pigment) were placed in a container and mixed with a TK homomixer (manufactured by PRIMIX Corporation) at 5,000 rpm for 60 minutes to obtain oil phase 1. The number of parts mentioned above represents the solid portion in each raw material.

Preparation of Aqueous Phase

A total of 990 parts of water, 20 parts of sodium dodecyl sulfate, and 90 parts of ethyl acetate were mixed and stirred to obtain a milky white liquid. This liquid was determined as aqueous phase 1.

Emulsification

A total of 20 parts of 28 percent ammonium water was added to 700 parts of the oil phase 1 while being stirred with a TK homomixer at a rate of rotation of 8,000 rpm. After mixing for 10 minutes, 1,200 parts of aqueous phase 1 was slowly added dropwise to the liquid mixture to obtain emulsified slurry 1.

Removal of Solvent

Emulsified slurry 1 was placed in a container equipped with a stirrer and a thermometer followed by purging the emulsified slurry 1 of the solvent at 30 degrees C. for 180 minutes to obtain solvent-purged slurry 1.

Aggregation and Shelling

A total of 100 parts of the solvent-purged slurry 1 and 300 parts of deionized water were placed in a vessel followed by stirring for one minute. Next, 100 parts of a 3 percent magnesium chloride solution were added dropwise followed by stirring for five minute and raising the temperature to 55 degrees C. Thereafter, when the particle diameter reached 5.0 μm, a liquid obtained by diluting 18.3 parts of shell emulsion 1, which is described later, with parts of water was added dropwise. Furthermore, 15 parts of a 3 percent magnesium chloride solution was added dropwise followed by stirring for 10 minutes. The resulting liquid was heated to 65 degrees C. followed by stirring for 30 degrees C. A total of 50 parts of sodium chloride was added to complete aggregation. Aggregated slurry 1 was thus obtained.

Fusion

The aggregated slurry 1 was stirred and heated to 70 degrees C. The heated aggregated slurry 1 was cooled down when the average circularity reached a target of 0.957. Slurry dispersion 1 was thus obtained.

Washing and Drying

After 100 parts of the slurry dispersion 1 was filtered under a reduced pressure, the following operations of 1 to 4 were conducted.

1: 100 parts of deionized water was added to the filtered cake followed by mixing with a TK HOMOMIXER at a rate of rotation of 12,000 rpm for 10 minutes;

2: 100 parts of sodium hydroxide at 10 percent was added to the filtered cake obtained in the 1 and the resulting mixture was mixed with a TK HOMOMIXER at 12,000 rpm for 30 minutes followed by filtering with under reduced pressure;

3: 100 parts of 10 percent hydrochloric acid was added to the filtered cake obtained in the 2 and the resulting mixture was mixed by a TK HOMOMIXER (at 12,000 rpm for 10 minutes) followed by filtering; and

4: 300 parts of deionized water was added to the filtered cake of the 3 and the resulting cake was mixed with a TK HOMOMIXER (at 12,000 rpm for 10 minutes) followed by filtering.

The operations 1 to 4 were repeated twice to obtain a filtered cake 1. The filtered cake 1 was dried with a circulating drier at 45 degrees C. for 48 hours. The dried cake was sieved using a screen with an opening of 75 μm to obtain mother resin particle 1.

Treatment with External Additive

A total of 2.0 parts of an external additive, hydrophobic silica (HDK-2000, manufactured by Clariant AG), was mixed with 100 parts of the mother resin particle 1 in a Henschel Mixer followed by filtering with a screen having an opening of 500 μm meshes to obtain resin particle 1.

The resin particles 2 to 10 were prepared in the same manner as the resin particle 1 except that the type and number of parts of the wax, binder resin, PET, and PBT were changed as shown in Table 2.

Preparation of Shell Emulsion

A total of 5.9 parts of 28 percent ammonium water was added to 400 parts of the shell resin 1 solution (90 percent petroleum-derived resin and 10 percent PET and/or PBT) to achieve a neutralization ratio of 100 percent in stirring with a TK Homomixer at a rate of rotation of 8,000 rotation per minute (rpm). After a 10 minute mixing, 600 parts of an aqueous phase was slowly added dropwise to phase-transfer emulsify the shell resin 1. The phase-transfer emulsified shell resin 1 was purged of the solvent with an evaporator to obtain shell emulsion 1.

Shell emulsion 2 was prepared in the same manner as the shell emulsion 1 except that the shell resin 2 (60 percent of petroleum-derived resin and 40 percent of PET and/or PBT) was phase-transfer emulsified instead of the shell resin 1.

Shell emulsions 3 to 10 were prepared in the same manner as in the shell emulsion 2.

The environmental friendliness, durability, and low temperature fixability of the toners using the resin particles 1 to 10 were evaluated. The following is the conditions for each evaluation. The results are shown in Table 3.

Environmental Friendliness

The environmental friendliness (environmental burden) of the toner was determined based on the environmental friendliness ratio in the toner. The evaluation criteria are as follows:

The toner graded A or B is evaluated as good and the toner graded C is evaluated as bad.

Evaluation Criteria

A: the plant-derived alcohol monomer accounting for 20 percent by mass or greater of the entire of the alcohol component of the first binder resin and polyethylene terephthalate accounting for 40 percent by mass or greater of the entire of the second binder resin

B: the plant-derived alcohol monomer accounting for 30 percent by mass or greater of the entire of the alcohol component of the first binder resin and polyethylene terephthalate accounting for 10 percent by mass or greater of the entire of the second binder resin

C: the plant-derived alcohol monomer accounting for 5 percent by mass or less of the entire of the alcohol component of the first binder resin and polyethylene terephthalate accounting for 5 percent by mass or less of the entire of the second binder resin

Durability

Toner is removed from the developing agent after printing with a photocopier with a run length of 100,000 sheets. The weight of the carrier is defined as W1. This carrier is poured in toluene to dissolve the molten material. The weight after rinsing and drying is defined as W2. The spent ratio is obtained according to the following relationship followed by evaluation. The toner graded A or B is evaluated as good and the toner graded C is evaluated as bad.

Spent ratio=(W1−W2)/W1×100

Evaluation Criteria

A: 0.01 to less than 0.02 percent by weight

B: 0.02 to less than 0.05 percent by weight

C: 0.05 percent by weight or greater

Low Temperature Fixability

The carrier for use in Imagio™ MP C5503, manufactured by Ricoh Co., Ltd. was mixed with the resin particle obtained as described above to achieve a concentration of the resin particle of 5 percent by mass, thereby obtaining a developing agent.

This developing agent was placed in the unit of Imagio™ MP C5503, manufactured by Ricoh Co., Ltd. Then an oblong solid image of 2 cm×15 cm was printed on PPC paper type 6000<70W>, A4 grain long (GL), manufactured by Ricoh Co., Ltd., with an amount of toner attached of 0.40 mg/cm². The image was printed using the fixing roller at different surface temperatures to check whether the developed image of the solid image was fixed at a position other than the target portion, which is a phenomenon called cold offset, to evaluate low temperature fixability. The toner graded A or B is evaluated as good and the toner graded C is evaluated as bad.

Evaluation Criteria

A: lower than 110 degrees

B: 110 to lower than 125 degrees

C: 125 degrees C. or higher

TABLE 3

| | Condition | | | | | | | |
|---|---|---|---|---|---|---|---|---|
| | | Plant- | | | | | | |
| | | derived | | | | | | |
| | | alcohol | | | | | | |
| | | monomer | | | | | | |
| | | (percent) | | | | Evaluation | | |
| | | in alcohol | PET | PET | | | | Low |
| | Resin | component | (percent) | (percent) | Shell's | Environmental | | temperature |
| | particle | in core | in core | in shell | thickness | friendliness | Durability | fixability |
| Example 1 | Resin | 5 | 0 | 10 | 1.005 | B | A | A |
| | particle | | | | | | | |
| | 4 | | | | | | | |
| Example 2 | Resin | 20 | 0 | 40 | 1.050 | A | A | A |
| | particle | | | | | | | |
| | 5 | | | | | | | |
| Example 3 | Resin | 30 | 0 | 70 | 1.500 | A | A | B |
| | particle | | | | | | | |
| | 6 | | | | | | | |
| Example 4 | Resin | 30 | 0 | 10 | 1.005 | A | B | B |
| | particle | | | | | | | |
| | 7 | | | | | | | |
| Example 5 | Resin | 5 | 4 | 10 | 1.005 | B | A | A |
| | particle | | | | | | | |
| | 8 | | | | | | | |
| Example 6 | Resin | 20 | 4 | 40 | 1.050 | A | A | A |
| | particle | | | | | | | |
| | 9 | | | | | | | |
| Example 7 | Resin | 30 | 4 | 70 | 1.500 | A | A | B |
| | particle | | | | | | | |
| | 10 | | | | | | | |
| Comparative | Resin | 0 | 0 | 0 | 0.0 | C | A | A |
| Example 1 | particle | | | | | | | |
| | 1 | | | | | | | |
| Comparative | Resin | 4 | 0 | 5 | 1.001 | C | C | A |
| Example 2 | particle | | | | | | | |
| | 2 | | | | | | | |
| Comparative | Resin | 40 | 0 | 80 | 1.750 | A | A | C |
| Example 3 | particle | | | | | | | |
| | 3 | | | | | | | |

As seen in the results shown in Table 3, the core's binder resin in a resin particle contains the plant-derived alcohol monomer in a proportion of from 5 to 35 percent by mass to the alcohol component in the core's binder resin and the shell's binder resin in the resin particle contains a polyethylene terephthalate resin in a proportion of from 10 to 70 percent by mass can produce toner with low environmental burden and excellent strength and low temperature fixability.

The aspects of the present disclosure are, for example, as follows:

1. A resin particle contains a core containing a first binder resin containing an alcohol component and a shell containing a second binder resin containing at least one of polyethylene terephthalate and polybutylene terephthalate, wherein the first binder resin contains a plant-derived alcohol monomer accounting for 5 to 35 percent by mass of the entire of the alcohol component and the at least one of polyethylene terephthalate or polybutylene terephthalate accounts for 10 to 70 percent by mass of the entire of the second binder resin.

2. The resin particle according to the 1 mentioned above, wherein the at least one of polyethylene terephthalate and polybutylene terephthalate contains a recycled resin.

3. The resin particle according to the 1 or 2 mentioned above, wherein the core further contains a third binder resin contains at least one of polyethylene terephthalate and polybutylene terephthalate and the proportion of the third binder resin is 10 percent by mass or less to the core.

4. The resin particle according to the 3 mentioned above, wherein the third binder resin contains a recycled resin.

5. The resin particle according to any one of the 1 to 4 mentioned above, wherein the shell has a thickness of 1.005 to 1.5, the thickness being the ratio of the average equivalent circle diameter of the resin particle to the average equivalent circle diameter of the core.

6. A toner contains the resin particle of any one of the 1 to 5 mentioned above. The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A resin particle comprising:
a core comprising a first binder resin comprising an alcohol component; and
a shell comprising a second binder resin comprising at least one of polyethylene terephthalate or polybutylene terephthalate,
wherein the first binder resin contains a plant-derived alcohol monomer accounting for 5 to 35 percent by mass of an entire of the alcohol component and
the at least one of polyethylene terephthalate or polybutylene terephthalate accounts for 10 to 70 percent by mass of an entire of the second binder resin.

2. The resin particle according to claim 1, wherein the at least one of polyethylene terephthalate or polybutylene terephthalate comprises a recycled resin.

3. The resin particle according to claim 1, wherein the core further comprises a third binder resin comprising at least one of polyethylene terephthalate or polybutylene terephthalate, the third binder resin accounts for 10 percent by mass or less of an entire of the core.

4. The resin particle according to claim 3, wherein the third binder resin comprises a recycled resin.

5. The resin particle according to claim 1, wherein the shell has a thickness of from 1.005 to 1.5, the thickness being a ratio of an average equivalent circle diameter of the resin particle to an average equivalent circle diameter of the core.

6. The resin particle according to claim 3, wherein the shell has a thickness of from 1.005 to 1.5, the thickness being a ratio of an average equivalent circle diameter of the resin particle to an average equivalent circle diameter of the core.

7. A toner comprising:
the resin particle of claim 1.
